(19) United States
(12) Patent Application Publication
(10) Pub. No.: US 2026/0346746 A1
(43) Pub. Date: Nov. 5, 2026

(54) AUTONOMOUS DEVICE, WORK ROBOT, AND CHARGING SYSTEM

(71) Applicant: SHENZHEN HANYANG TECHNOLOGY CO., LTD., Shenzhen (CN)

(72) Inventors: Taotao ZHU, Shenzhen (CN); Yongqi SONG, Shenzhen (CN); Weiyue CHEN, Shenzhen (CN)

(21) Appl. No.: 19/707,193

(22) Filed: Jun. 12, 2026

Related U.S. Application Data
(63) Continuation of application No. PCT/CN2023/135923, filed on Dec. 1, 2023.

(30) Foreign Application Priority Data
Jun. 16, 2023 (CN) 202310725079.3
Aug. 8, 2023 (CN) 202322118614.7

(51) Int. Cl. B60L 53/38; B60L 53/12; B62D 55/08; E01H 5/09; H02J 50/00; H02J 50/10; H02J 50/90

(52) U.S. Cl. CPC B60L 53/38; B60L 53/12; B62D 55/08; H02J 50/005; H02J 50/10; H02J 50/90; E01H 5/098

(57) ABSTRACT

An autonomous device, a work robot, and a charging system are disclosed. The autonomous device may be configured to be charged via a charging pile, and the autonomous device includes a vehicle body, a traveling assembly, a storage battery, and a charging assembly. The traveling assembly is disposed at a bottom of the vehicle body and configured to drive the vehicle body to perform a moving operation. The storage battery is mounted on the vehicle body. The charging assembly is configured to be coupled to the charging pile so as to receive electric energy from the charging pile to charge the storage battery, and the charging assembly is disposed at the bottom of the vehicle body. Thus, the work robot and the charging pile may adopt a bottom-to-top charging structure, and the entire vehicle body may play a shielding role for the charging assembly disposed at the bottom of the vehicle body. When the work robot works outdoors on a snowy day, the vehicle body may prevent snow from falling to a surface of the charging assembly, so that difficult charging caused by snow accumulation or agglomeration on the surface of the charging assembly may be mitigated, which facilitates the work robot in finishing a charging task smoothly.

### CROSS-REFERENCE TO RELATED APPLICATION(S)

This patent document claims priority to and the benefits of PCT Application No. PCT/CN2023/135923 filed on Dec. 1, 2023, which claims priority to and the benefits of Chinese Patent Application Nos. 202310725079.3 filed on Jun. 16, 2023 and 202322118614.7 filed on Aug. 8, 2023, the contents of each of which are hereby incorporated herein by reference.

### TECHNICAL FIELD

The present disclosure relates to the technical field of robots, in particular to an autonomous device, a work robot, and a charging system.

### BACKGROUND

With the rapid development of robotics technology, household robots (e.g., snow cleaning robots) have begun to enter every corner of daily life. A snow cleaning robot may include a snow cleaning implement and a carrier for dragging the snow cleaning implement to move in a courtyard. The carrier may be a wheeled or crawler-type vehicle body, and the snow cleaning implement may include a snow rolling implement and a snow throwing implement. The snow rolling implement may gather accumulated snow on the ground into a snow rolling cabin, and then the snow throwing implement may throw the accumulated snow in the snow rolling cabin in a specified direction.

In pursuit of the concept of low carbon, environmental protection, energy conservation, and emission reduction, traditional snow cleaning robots powered by fuel oil are being gradually phased out. The mainstream development direction of existing snow cleaning robots may be to adopt an electric structure powered by a storage battery. An existing charging assembly may be disposed on a side face of the vehicle body of the snow cleaning robot. The charging assembly on the side face of the vehicle body may be brought close to a charging pile by the movement of the snow cleaning robot, to facilitate electrical connection with the charging pile.

Since the snow cleaning robot may perform snow clearing work while it is snowing, the vehicle body of the snow cleaning robot may be highly susceptible to snow cover or the formation of hard snow blocks on its surface, which may bring difficulties to the charging of the snow cleaning robot.

### SUMMARY

Embodiments of the present technology provide an autonomous device, a work robot, and a charging system.

According to a first aspect of the present disclosure, some embodiments of the technology provide an autonomous device. The autonomous device may be configured to be charged via a charging pile. The autonomous device may include a vehicle body, a traveling assembly, a storage battery, and a charging assembly. The traveling assembly may be disposed at a bottom of the vehicle body and configured to drive the vehicle body to perform a moving operation. The storage battery may be mounted on the vehicle body. The charging assembly may be configured to be coupled to the charging pile so as to receive electric energy from the charging pile to charge the storage battery, and the charging assembly may be disposed at the bottom of the vehicle body.

According to a second aspect of the present disclosure, some embodiments of the technology provide a work robot. The work robot may include a work implement and the above autonomous device, and the work implement may be connected to a vehicle body of the autonomous device.

According to a third aspect of the present disclosure, some embodiments of the technology provide a charging system. The charging system may include the above work robot and a charging pile. The charging pile may include a base plate and a power assembly, and the power assembly may be disposed on the base plate and configured to couple with a charging assembly of the work robot. The base plate may be configured for parking of the work robot, and when the work robot is parked on the base plate for charging, the power assembly may be located under the charging assembly.

### BRIEF DESCRIPTION OF THE DRAWINGS

In order to explain technical solutions in embodiments of the present technology more clearly, the following will briefly introduce the accompanying drawings that may be used in the descriptions of the embodiments. Apparently, the accompanying drawings in the following descriptions are some embodiments of the present technology, and for a person skilled in the art, on the premise of no creative labor, other accompanying drawings can further be obtained from these accompanying drawings.

FIG. 1 is a schematic structural diagram of a charging system according to some embodiments of the present technology.

FIG. 2 is a schematic structural diagram of a charging pile in the charging system shown in FIG. 1.

FIG. 3 is a schematic structural diagram of a work implement in the charging system shown in FIG. 1.

FIG. 4 is a schematic structural diagram of an autonomous device in the charging system shown in FIG. 1.

FIG. 5 is a schematic sectional view of the autonomous device shown in FIG. 4.

FIG. 6 is a schematic exploded view of a charging assembly in the autonomous device shown in FIG. 4.

FIG. 7 is a schematic structural diagram of a charging assembly in a mounted state in the autonomous device shown in FIG. 4.

FIG. 8 is a schematic structural diagram of a charging assembly in a detached state in the autonomous device shown in FIG. 4.

FIG. 9 is a schematic structural diagram of a vehicle body, a charging assembly, and a latch assembly in the autonomous device shown in FIG. 4.

FIG. 10 is a schematic exploded view of the latch assembly shown in FIG. 9.

FIG. 11 is a schematic sectional view of the latch assembly shown in FIG. 9.

Reference numerals: 10, charging system; 20, charging pile; 210, base plate; 230, power assembly; 2320, transmitting coil; 30, work robot; 320, work implement; 3200, snow cleaning implement; 3201, housing body; 3210, snow rolling implement; 3212, snow rolling cabin; 3214, snow rolling blade; 3216, snow rolling output shaft; 3230, snow throwing implement; 3232, snow throwing cabin; 340, autonomous device; 3410, vehicle body; 3412, bottom surface; 3414, accommodating chamber; 3416, inner wall; 3418, latching hole; 3420, traveling assembly; 3421, crawler track; 3430, storage battery; 3490, baffle assembly; 3492, baffle; 3460, actuator; 3440, charging assembly; 3441, receiving coil; 3443, coil positioning sensor; 3445, inductor; 3447, charging circuit board; 2340, marking coil; 3470, controller; 3450, housing; 3451, charging surface; 3454, upper housing; 3455, lower housing; 3456, sealing member; 3480, limiting assembly; 3481, first limiting portion; 3482, second limiting portion; 3483, limiting boss; 3484, limiting groove; 3500, latch assembly; 3510, shell; 3512, base; 3514, hood; 3516, through hole; 3520, latch bolt; 3521, latching portion; 3530, elastic member; 3532, spring; 3540, guide pillar; 3518, guide platform; 3523, guide groove; 3453, fixing platform; 3550, lug; 3552, penetrating hole; 3560, fastening member; and 3234, snow throwing bucket.

### DETAILED DESCRIPTION

In order to make a person skilled in the art better understand the solutions of the present technology, the following describes the technical solutions in embodiments of the present technology with reference to the accompanying drawings in the embodiments of the present technology. Apparently, the described embodiments are a part of the embodiments of the present technology, not all of the embodiments. Based on the embodiments in the present technology, other embodiments obtained by a person skilled in the art without creative effort may fall within the scope of the present disclosure.

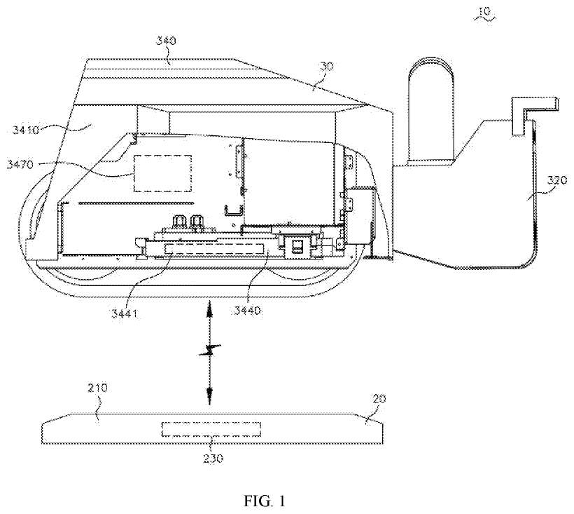

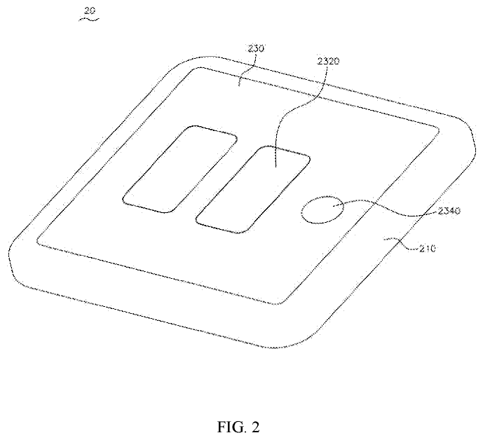

Referring to FIG. 1 and FIG. 2, some embodiments discloses a charging system 10. The charging system 10 may include a charging pile 20 and a work robot 30. The work robot 30 may be configured to be electrically connected to the charging pile 20, so that the charging pile 20 may charge the work robot 30.

In such embodiments, the charging pile 20 may include a base plate 210 and a power assembly 230. The base plate 210 may be configured for parking of the work robot 30. The power assembly 230 may be disposed on the base plate 210, and the base plate 210 may further provide a fixing and protecting structure for the power assembly 230. Specifically, the power assembly 230 may be configured to couple with a charging assembly 3440 of the work robot 30. For example, the power assembly 230 may include a transmitting coil 2320, the charging assembly 3440 may include a receiving coil 3441 configured to be coupled to the transmitting coil 2320, and the receiving coil 3441 can receive electromagnetic waves emitted by the transmitting coil 2320 to achieve wireless charging between the charging pile 20 and the work robot 30. For another example, the power assembly 230 may include a plug (e.g., a plug with pins), and the charging assembly 3440 may include a socket configured to couple with the plug. For instance, the socket may be a conductive disk. In a case where the plug abuts against the conductive disk through the pins, wired charging between the charging pile 20 and the work robot 30 can be achieved.

In some embodiments, in a case where the power assembly 230 includes the transmitting coil 2320, the power assembly 230 may further include a frequency converter (not shown). The transmitting coil 2320 may be connected to a power source input into the charging pile 20 through the frequency converter, and a frequency of an input voltage may be adjusted through the frequency converter. If the input voltage is an alternating current, a frequency of the alternating voltage may be adjusted through the frequency converter, so that charging efficiency of the work robot 30 may be controlled. If the input voltage is a direct current, the power assembly 230 further may include an oscillating circuit (not shown) which may be configured to filter the input direct current so as to form a pulsating direct current. The charging efficiency of the work robot 30 may be controlled by changing a frequency of the pulsating direct current through the frequency converter. Specifically, the frequency converter may include a rectifier unit, a filter unit, an inverter unit, a braking unit, a microprocessing unit, and the like. The oscillating circuit may be an LC oscillating circuit, and the specific implementations of the frequency converter and the oscillating circuit are not limited in such embodiments.

In such embodiments, the work robot 30 may include a work implement 320 and an autonomous device 340. The work implement 320 may be connected to a vehicle body 3410 of the autonomous device 340, and the work implement 320 may be configured to achieve different functions corresponding to the work robot 30. For example, in a case where the work robot 30 may be a snow cleaning robot, the work implement 320 may be a snow removing implement, a snow pushing implement, and the like. For another example, in a case where the work robot 30 may be a weeding robot, the work implement 320 may be a weeding implement, a mowing implement, and the like. Specifically, the work implement 320 may be a snow removing implement, a snow rolling implement, a snow throwing implement, a weeding implement, a mowing implement, a leaf blowing implement, a salt spreading implement, a roller brush assembly, a snow pushing implement, and the like, and the specific implementation of the work implement 320 is not limited in such embodiments. The autonomous device 340 may be configured to drag the work implement 320 to work. The autonomous device 340 may be provided with the above charging assembly 3440, so that the autonomous device 340 may be configured to be charged through the charging pile 20.

In some embodiments, the work implement 320 may be a snow cleaning implement 3200. The snow cleaning implement 3200 may be configured to remove accumulated snow on road surfaces. The snow cleaning implement 3200 in some embodiments may include a snow rolling implement 3210 and a snow throwing implement 3230. The snow rolling implement 3210 may be provided with a snow rolling cabin 3212 which may be internally provided with snow rolling blades 3214 for gathering the accumulated snow. The snow throwing implement 3230 may be provided with a snow throwing cabin 3232 communicating with the snow rolling cabin 3212. The snow throwing cabin 3232 may be internally provided with snow throwing blades (not shown) for throwing out the accumulated snow in the snow rolling cabin 3212. The snow throwing cabin 3232 may be located on a central axis of the snow rolling cabin 3212, the snow rolling blades 3214 may be fixed onto a snow rolling output shaft 3216, and two groups of snow rolling blades 3214 may be symmetrically disposed with respect to the central axis of the snow rolling cabin 3212. A spiral direction of each group of snow rolling blades 3214 may face the central axis of the snow rolling cabin 3212. Therefore, when the snow rolling output shaft 3216 rotates, the two groups of snow rolling blades 3214 may be driven to gather the accumulated snow in the snow rolling cabin 3212 to a center of the snow rolling cabin 3212 simultaneously. With continuous advancing of the work robot 30, the accumulated snow gathered at the center of the snow rolling cabin 3212 may be pushed deeper into the snow rolling cabin 3212 by continuously incoming new accumulated snow, that is, the accumulated snow may be pushed towards the snow throwing cabin 3232 communicating with the snow rolling cabin 3212, and the accumulated snow may be thrown out along a snow throwing bucket 3234 by the acting of the snow throwing blades.

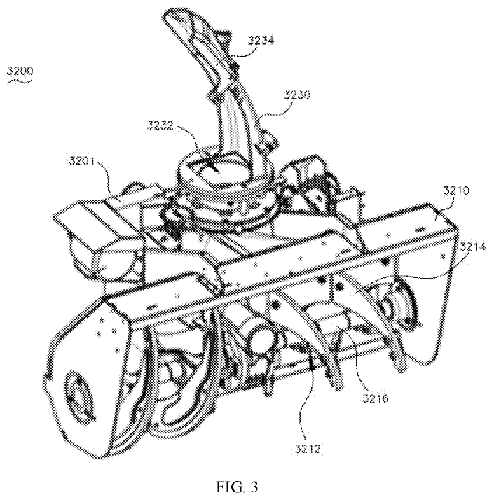

Specifically, in the embodiments shown in FIG. 3, the snow rolling cabin 3212 may have a semi-enclosed structure, and a portion thereof facing forwards may be provided with an opening, and in this way, when the work robot 30 travels, the snow rolling cabin 3212 may scoop up the oncoming accumulated snow into itself. The snow throwing cabin 3232 may be disposed on one side of the snow rolling cabin 3212 facing away from the opening, the snow throwing bucket 3234 communicating with the snow throwing cabin 3232 may be disposed outside the snow cleaning implement 3200, an inside of the snow rolling cabin 3212 may be a curved inner cavity, and a section of the inner cavity may be gradually reduced from the opening to the snow throwing cabin 3232. As such, the snow rolling blades 3214 may be used to gather the accumulated snow in the snow rolling cabin 3212, with the advancing of the work robot 30, the accumulated snow gathered in the snow rolling cabin 3212 may be collected by a cabin wall of the snow rolling cabin 3212 with the gradually reducing section and propelled towards the snow throwing cabin 3232, and then the accumulated snow may be thrown out by the snow throwing bucket 3234 via the snow throwing blades in the snow throwing cabin 3232.

In some embodiments, the snow cleaning implement 3200 may further include an actuator (not shown) for driving the snow rolling blades 3214 and the snow throwing blades to operate. For example, the actuator may be a motor. The motor may be powered by a storage battery 3430 disposed in the autonomous device 340. In this way, compared to a traditional snow cleaning robot powered by fuel oil, a drive system in the work robot 30 disclosed in the embodiments may have a smaller size, realizing a miniaturized design of the work robot 30.

Further, a root of the snow throwing bucket 3234 may be fixedly connected to a housing body 3201 of the snow cleaning implement 3200, the snow throwing bucket 3234 may be in an arc shape, and an end thereof may extend in a vertical direction and may be gradually curved to a horizontal direction at the same time. In order to achieve a high snow throwing lift with limited energy consumption, in such embodiments, a central angle of a center line of the snow throwing bucket 3234 may be 45°, that is, a direction of the accumulated snow's velocity at the moment it exits a snow throwing opening may form a 45° angle with the horizontal direction. Since accumulated snow of the same mass achieves a greater throwing distance in the horizontal direction when thrown out at an angle of 45° upward and obliquely with the same initial velocity, such structural design enables an optimal snow throwing lift to be obtained on the premise of unchanged energy consumption (i.e., the initial velocity of the accumulated snow when exiting the snow throwing opening remains unchanged), and the accumulated snow may be thrown farther, thereby improving the snow throwing efficiency of the work robot 30, and reducing the energy consumption of the work robot 30.

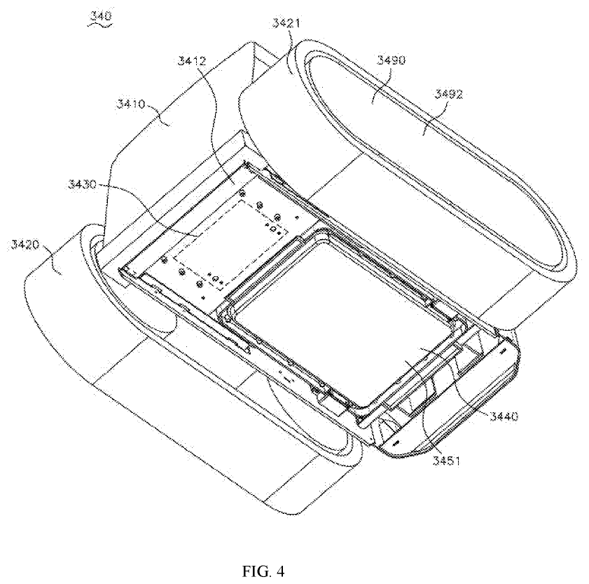

Referring to FIG. 4, the autonomous device 340 may include the vehicle body 3410, a traveling assembly 3420, the storage battery 3430, and the charging assembly 3440. The traveling assembly 3420 may be disposed at a bottom of the vehicle body 3410 and configured to drive the vehicle body 3410 to perform a moving operation. The storage battery 3430 may be mounted on the vehicle body 3410. The charging assembly 3440 may be configured to be coupled to the charging pile 20 so as to receive electric energy from the charging pile 20 to charge the storage battery 3430, and the charging assembly 3440 may be disposed at the bottom of the vehicle body 3410.

Since the charging assembly 3440 may be disposed at the bottom of the vehicle body 3410, when the work robot 30 is parked on the base plate 210 of the charging pile 20 for charging, the power assembly 230 may be located under the charging assembly 3440. Thus, the present disclosure may adopt a bottom-to-top charging structure of the power assembly 230 and the charging assembly 3440, and the entire vehicle body 3410 may shield the charging assembly 3440 disposed at the bottom of the vehicle body 3410. When the work robot 30 works outdoors on a snowy day, the vehicle body 3410 can prevent snow from falling to a surface of the charging assembly 3440, so that difficult charging caused by snow accumulation or agglomeration on the surface of the charging assembly 3440 may be mitigated, which facilitates the work robot 30 in completing a charging task.

In the following, the structure of the autonomous device 340 is introduced in detail.

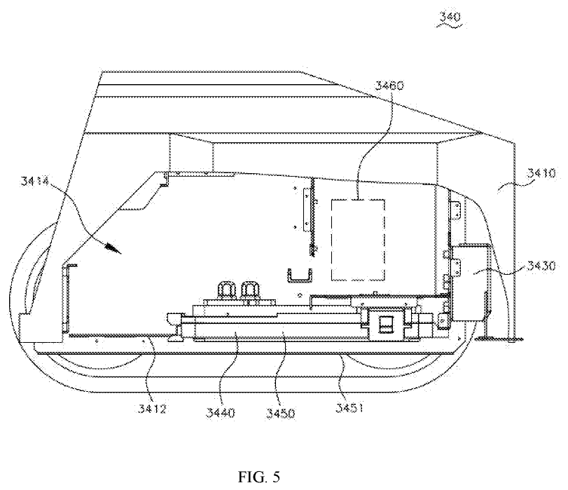

In such embodiments, the vehicle body 3410 may be configured to fix and support the storage battery 3430 and the charging assembly 3440. Referring to FIG. 5, the vehicle body 3410 may be provided with an accommodating chamber 3414, which may be approximately located at the bottom of the vehicle body 3410, and the storage battery 3430 and the charging assembly 3440 may be disposed in the accommodating chamber 3414 to protect the storage battery 3430 and the charging assembly 3440.

In such embodiments, the storage battery 3430 may be mounted on the vehicle body 3410. In one aspect, the storage battery 3430 may be electrically connected to the traveling assembly 3420, and configured to provide electric energy to power movement of the autonomous device 340. In another aspect, the storage battery 3430 may be further electrically connected to the work implement 320, and configured to provide electric energy to drive the work implement 320 to work. Specifically, the storage battery 3430 may be a lead-acid storage battery, a nickel-metal hydride storage battery, a lithium-ion battery, and the like, which is not specifically limited in such embodiments.

In such embodiments, the traveling assembly 3420 may be disposed at the bottom of the vehicle body 3410 and configured to drive the vehicle body 3410 to perform a moving operation. Specifically, the traveling assembly 3420 may be disposed at the bottom of the vehicle body 3410 and may support the vehicle body 3410 to enable the bottom of the vehicle body 3410 to be spaced from a ground surface, and the charging assembly 3440 may be exposed at the bottom of the vehicle body 3410. Therefore, when the work robot 30 travels to a location above the charging pile 20, the charging assembly 3440 located at the bottom of the vehicle body 3410 may keep a certain space from the charging pile 20, so as to help avoid collision of the charging assembly 3440 and the charging pile 20.

In some embodiments, referring to FIG. 4 again, the traveling assembly 3420 may include two crawler tracks 3421, the two crawler tracks 3421 may be located on left and right sides in a traveling direction of the vehicle body 3410, and the charging assembly 3440 may be exposed in a space between the two crawler tracks 3421. Therefore, in the traveling process of the vehicle body 3410, the two crawler tracks 3421 located on the two sides of the vehicle body 3410 may avoid accumulated snow from coming to the vehicle bottom from the left and right sides of the vehicle body 3410 to a certain extent, so that contact of the accumulated snow from the ground with the charging assembly 3440 may be avoided, the probability that the surface of the charging assembly 3440 is covered by snow blocks or ice blocks due to the accumulated snow on the ground may be lowered, and charging of the autonomous device 340 can be facilitated. In some embodiments, the traveling assembly 3420 may include a plurality of driving wheels, and the plurality of driving wheels may be disposed at the bottom of the vehicle body 3410 to drive the vehicle body 3410 to perform a moving operation. An implementation of the traveling assembly 3420 is not specifically limited in such embodiments.

In some embodiments, the autonomous device 340 further may include a baffle assembly 3490, the baffle assembly 3490 may include two baffles 3492, and the two baffles 3492 may be disposed on side faces of the two crawler tracks 3421 respectively and may shield the space between the two crawler tracks 3421. Therefore, when the vehicle body 3410 travels in snow, the two baffles 3492 and the two crawler tracks 3421 can further block the accumulated snow on the ground from coming to the vehicle bottom from the bottoms of the two sides of the vehicle body 3410. In addition, the work implement 320 located on the front portion of the vehicle body 3410 may also block the accumulated snow on the ground from coming to the vehicle bottom from the front portion of the vehicle body 3410, such that the baffles 3492, the crawler tracks 3421, and the work implement 320 may form a three-face enclosing structure for the bottom of the vehicle body 3410. Even though the autonomous device 340 proceeds through a snowfield with a certain thickness, the accumulated snow may be restricted from coming to the vehicle bottom from the two sides and the front portion of the vehicle body 3410, so that contact of the accumulated snow from the ground with the charging assembly 3440 may be avoided, the probability that the surface of the charging assembly 3440 is covered by snow blocks or ice blocks due to the accumulated snow on the ground may be lowered, and charging of the autonomous device 340 can be facilitated.

Further, when encountering snowstorm weathers, as the baffles 3492, the crawler tracks 3421, and the work implement 320 may completely cover the two sides and the front portion of the bottom of the vehicle body 3410, snow lifted by wind may be restricted from entering the vehicle bottom. In this way, accumulated snow from the sky and the ground may be restricted from making contact with the charging assembly 3440, which is beneficial for realizing automatic charging of the autonomous device 340.

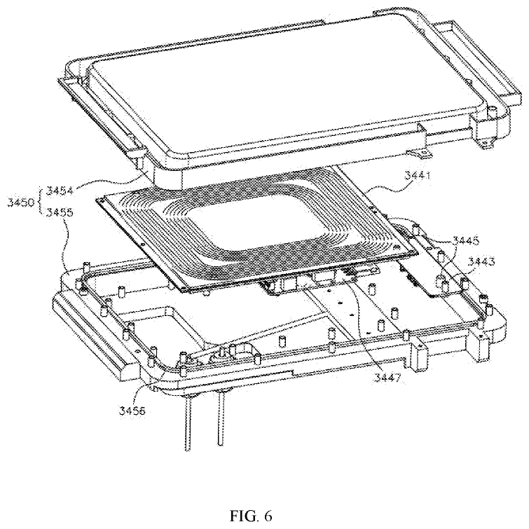

In such embodiments, the charging assembly 3440 may be configured to be coupled to the charging pile 20 so as to receive electric energy from the charging pile 20 to charge the storage battery 3430. Referring to FIG. 6, the charging assembly 3440 may include a housing 3450 and the receiving coil 3441. The housing 3450 may be mounted at the bottom of the vehicle body 3410, the receiving coil 3441 may be configured to be coupled to the transmitting coil 2320 located on the charging pile 20, and the receiving coil 3441 may be disposed in the housing 3450 and electrically connected to the storage battery 3430.

Therefore, in such embodiments, the charging pile 20 and the work robot 30 may adopt a wireless charging manner for charging. Compared to traditional wired connections, such as a contact connection between the pins and the conductive disk, the wireless charging manner may mitigate issues such as poor contact of electric contact members (e.g., plugs and sockets) caused by rusting, dust, dirt, and abrasion. In addition, compared to direct plug-in charging, as no plug is used, manual intervention may be avoided. The work robot 30 may be wirelessly charged just by traveling to a location corresponding to the charging pile 20, the step of manual plugging of a charging plug may be omitted, and the charging process may be automated.

In some embodiments, the charging assembly 3440 may further include a charging circuit board 3447, and the receiving coil 3441 may be electrically connected to the storage battery 3430 through the charging circuit board 3447. Specifically, the charging circuit board 3447 may be integrated with a rectifying circuit, a filter circuit, a voltage stabilizing circuit, and other circuit structures, such that the receiving coil 3441 may charge the storage battery 3430 by supplying an induced voltage through the charging circuit board 3447 after rectification, filtering, and voltage stabilization, so as to facilitate a smooth charging process.

In such embodiments, the housing 3450 may provide a good airtight space to help protect internal elements and components, so as to help prevent the internal elements and components (e.g., the receiving coil 3441) from being eroded by external environments such as rain and snow, wind-blown sand, and tidal air. Specifically, the housing 3450 may include an upper housing 3454 and a lower housing 3455 connected with each other. The upper housing 3454 and the lower housing 3455 may be buckled together to form an airtight space for accommodating the receiving coil 3441 and the charging circuit board 3447.

Since the receiving coil 3441 and the charging circuit board 3447 inside the charging assembly 3440 may be prone to generating heat, the charging assembly 3440 may benefit from good heat dissipation. To address this, one of the upper housing 3454 and the lower housing 3455 may include a plastic material, and the other one may include a metal material. The housing of the metal material may have high heat conductivity, and may rapidly dissipate heat inside the charging assembly 3440. The housing of the plastic material may avoid blocking by metal during the reception of a magnetic field of the charging assembly 3440, so that the receiving coil 3441 may work normally. In such embodiments, the housing 3450 may adopt a combined form of metal and plastic, while a good receiving capability may be achieved, heat dissipation may also be considered, so that the elements and components inside the housing may work in a stable environment, and the service lives of the internal elements and components may be prolonged.

Specifically, the upper housing 3454 may be located on one side of the housing 3450 facing the charging pile 20, and the upper housing 3454 may be of a plastic material (e.g., a thermoplastic material, a thermosetting material, etc.). The lower housing 3455 may be located on one side of the housing 3450 away from the charging pile 20, and the lower housing 3455 may be of a metal material (e.g., alloy, stainless steel, etc.). Therefore, when the work robot 30 may be charged, the upper housing 3454 may be located between the charging pile 20 and the receiving coil 3441, mitigating the issue of a magnetic field produced by the receiving coil 3441 being blocked by the upper housing 3454 of the plastic material. The lower housing 3455 may be located on the side of the receiving coil 3441 facing away from the charging pile 20, such that heat produced by the receiving coil 3441 due to electromagnetic induction may be dissipated rapidly, facilitating smooth working of the charging assembly 3440.

In some embodiments, the housing 3450 may further include a sealing member 3456, and the upper housing 3454 and the lower housing 3455 may be sealed by the sealing member 3456. The sealing member 3456 may improve the good sealed effect of the housing 3450 to help avoid entry of rain and snow, wind-blown sand, tidal air, and the like into the housing 3450, further promoting the stability of the working environment of the elements and components inside the housing 3450. Specifically, the sealing member 3456 may be a sealing ring or a sealing strip.

In some embodiments, the charging assembly 3440 may further include a coil positioning sensor 3443, and the coil positioning sensor 3443 may be disposed in the housing 3450 and configured to detect a location of the charging assembly 3440 relative to the charging pile 20. In such embodiments, the coil positioning sensor 3443 may be used to detect a magnetic field change of the charging pile 20, so as to determine a distance and angle of the charging assembly 3440 relative to the charging pile 20, and thus whether the work robot 30 enters a charging region may be recognized, and then whether the receiving coil 3441 of the work robot 30 is turned on or off may be determined.

In such embodiments, by disposing the coil positioning sensor 3443, the charging assembly 3440 may mitigate the issue that the charging assembly 3440 is prone to misalignment during use, which may result in low charging efficiency and even no-load charging. Further, in such embodiments, the charging assembly 3440 may integrate a positioning function and a wireless charging receiving function, and may have advantages such as high integration, compact structure, and convenient mounting.

Specifically, referring to FIG. 2 and FIG. 6 respectively, the charging pile 20 may further include a marking coil 2340, and the coil positioning sensor 3443 may include a pair of inductors 3445 (e.g., a coil inductor, a plug-in inductor, etc.). The pair of inductors 3445 may be configured to detect a magnetic field intensity of the marking coil 2340 to determine a location of the charging assembly 3440 relative to the charging pile 20. For example, the marking coil 2340 in the charging pile 20 may be normally open to form a marking magnetic field at the location where the charging pile 20 is located. In such embodiments, by a numeric value difference of the marking magnetic field acquired by the pair of inductors 3445, the distance and angle of the charging assembly 3440 relative to the charging pile 20 can be determined. If it is recognized that the work robot 30 has traveled to a region above the charging pile 20, the transmitting coil 2320 of the charging pile 20 and the receiving coil 3441 of the work robot 30 may be turned on to achieve wireless charging of the work robot 30. In some embodiments, the coil positioning sensor 3443 may further be an LC resonance circuit composed of an inductor and a capacitor.

In some embodiments, the autonomous device 340 may further include a controller 3470. The controller 3470 may be mounted in the accommodating chamber 3414, and configured to control a motion state of the work robot 30 and control the work robot 30 to move. Specifically, the controller 3470 may be a controller, such as a microcontroller unit (MCU). In some embodiments, a signal amplifying circuit (not shown) may further be disposed in the controller 3470, and the signal amplifying circuit may be configured to amplify a received signal (e.g., an electromagnetic wave) to facilitate subsequent signal processing.

In such embodiments, the controller 3470 may be electrically connected to the coil positioning sensor 3443, and may be configured to acquire an electromagnetic wave received by the coil positioning sensor 3443, process the received electromagnetic wave to obtain electromagnetic wave intensity distribution information, and determine the location of the charging assembly 3440 relative to the charging pile 20 according to the electromagnetic wave intensity distribution information. The electromagnetic wave intensity distribution information may be electromagnetic wave intensity information at the current location of the work robot 30 and electromagnetic wave range distribution information.

In some embodiments, the controller 3470 may determine a location offset of the work robot 30 based on the determined location of the charging assembly 3440 relative to the charging pile 20 and a current motion state of the work robot 30, and correct the motion state of the work robot 30 based on the location offset, so that the work robot 30 may smoothly move to the location where the charging pile 20 is located. Therefore, issues with the work robot 30 locating the charging pile 20 accurately when needing charging may be mitigated, and the charging efficiency of the work robot 30 may be improved.

In the following, a connection method between the housing 3450 and the vehicle body 3410 may be described.

In some embodiments, the housing 3450 may be fixedly connected to the bottom of the vehicle body 3410. Referring to FIG. 4 again, the housing 3450 may be provided with a charging surface 3451 corresponding to the transmitting coil 2320. The charging surface 3451 may protrude relative to a bottom surface 3412 of the vehicle body 3410, such that when the work robot 30 travels to the location above the charging pile 20, the charging surface 3451 may be closer to an upper surface of the charging pile 20, so that electromagnetic coupling efficiency of the transmitting coil 2320 in the charging pile 20 may be improved, and the charging efficiency of the work robot 30 may be improved. Specifically, the “charging surface 3451” here may be a surface of the housing 3450 facing the charging pile 20. As an implementation, part of structures (e.g., one of the upper housing 3454 or the lower housing 3455) in the housing 3450 and the vehicle body 3410 may be of an integrally formed structure, so that the connection reliability between the vehicle body 3410 and the charging assembly 3440 may be improved.

In some embodiments, the autonomous device 340 may further include an actuator 3460, and the actuator 3460 may be disposed in the accommodating chamber 3414 and may be operatively coupled to the housing 3450. The actuator 3460 may be configured to drive the housing 3450 to move in the accommodating chamber 3414 so as to achieve switching between an extended state and a retracted state. Specifically, the actuator 3460 may be a linear actuator (e.g., a linear motor, a cylinder, etc.), and the linear actuator may directly drive the housing 3450 to go up and down in a designated direction. The designated direction may refer to a direction perpendicular to a plane where the bottom surface 3412 of the vehicle body 3410 may be located.

Specifically, the housing 3450 may be provided with the charging surface 3451 corresponding to the transmitting coil 2320. When the charging assembly 3440 is located at the extended state, the charging surface 3451 may protrude relative to the bottom surface 3412 of the vehicle body 3410 or may be flush with the bottom surface 3412 of the vehicle body 3410; and when the charging assembly 3440 is located at the retracted state, the charging surface 3451 may be concealed in the accommodating chamber 3414. When the charging assembly 3440 is located at the extended state, the charging assembly 3440 may be in a non-charging state, and at the moment, the charging surface 3451 may extend out of the accommodating chamber 3414. When the charging assembly 3440 is located at the retracted state, the charging assembly 3440 may be in a charging state, and at the moment, the charging surface 3451 may retract back into the accommodating chamber 3414.

By adopting such mechanism design, the housing 3450 in the non-charging state may be located at the extended state, and when agglomerates (frost blocks, snow blocks or ice blocks) form on the surface of the charging surface 3451, since the housing 3450 in the charging state may retract upwards into the accommodating chamber 3414, the agglomerates (e.g., frost blocks, snow blocks, ice blocks, etc.) on the surface of the charging surface 3451 may be subjected to normal stress caused by the blocking of a chassis of the vehicle body 3410, so that they may be squeezed against each other, broken and separated from the housing 3450. This may help prevent impurities such as agglomerates from existing between the charging surface 3451 and the charging pile 20 when the work robot 30 travels to the location above the charging pile 20, thereby facilitating smooth wireless charging of the work robot 30 and facilitating intelligent operation of the work robot 30. That is, the work robot 30 may have the capability of automatic charging in a low-power state, so as to realize automated working to the greatest extent and reduce the need for manual charging operations for the work robot 30.

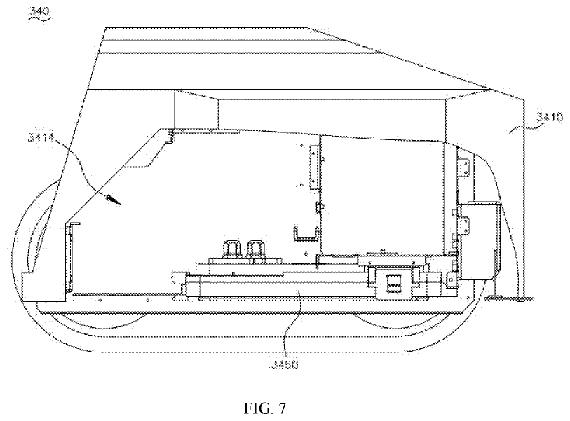

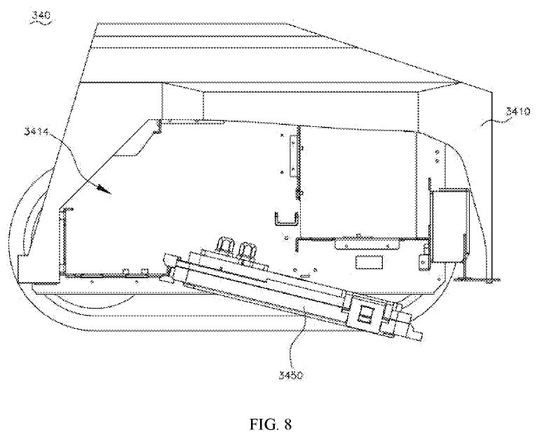

In yet some embodiments, the housing 3450 may be detachably disposed in the accommodating chamber 3414. Referring to FIG. 7 and FIG. 8 respectively, in FIG. 7, the housing 3450 is shown in a mounted state, and in FIG. 8, the housing 3450 is shown in a detached state. In such embodiments, the autonomous device 340 may further include a limiting assembly 3480. The limiting assembly 3480 may be connected between the housing 3450 and the vehicle body 3410, so that the housing 3450 may be detachably connected to the vehicle body 3410. Therefore, during abnormal charging of the work robot 30, a user or a serviceman may quickly detach the charging assembly 3440 from the vehicle body 3410, which may improve the convenience of checking and repairing.

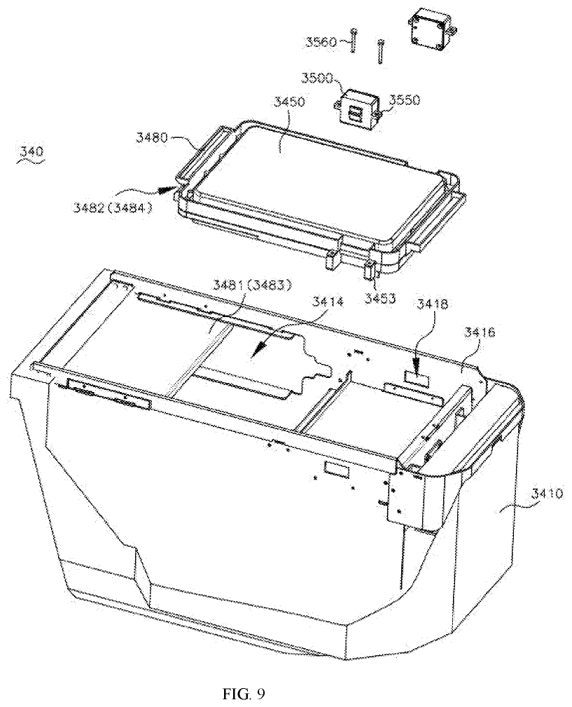

As an implementation, referring to FIG. 9, the limiting assembly 3480 may include a first limiting portion 3481 and a second limiting portion 3482. The first limiting portion 3481 and the second limiting portion 3482 may be in plug-in fit to position the housing 3450. The first limiting portion 3481 may be disposed at one end of the accommodating chamber 3414 and connected to the vehicle body 3410, the second limiting portion 3482 may be disposed on the housing 3450, and the second limiting portion 3482 may be limited at the first limiting portion 3481 to fix a mounting location of the housing 3450 relative to the vehicle body 3410. Specifically, one of the first limiting portion 3481 and the second limiting portion 3482 may be a limiting boss 3483, the other one may be a limiting groove 3484, and the limiting boss 3483 may be inserted and nested within the limiting groove 3484.

In the embodiments shown in FIG. 9, the first limiting portion 3481 may be the limiting boss 3483, and the second limiting portion 3482 may be the limiting groove 3484. Specifically, the limiting boss 3483 may be approximately in a long strip shape and may be located at the bottom of the vehicle body 3410 and one end of the accommodating chamber 3414, the limiting groove 3484 may be disposed at one end of the housing 3450, and the limiting groove 3484 may match with the limiting boss 3483 in shape and size, so that one end of the housing 3450 may be stably held. In some embodiments, the first limiting portion 3481 may be the limiting groove 3484, and the second limiting portion 3482 may be the limiting boss 3483, which is not specifically limited in the present disclosure.

In the embodiments shown in FIG. 9, latching holes 3418 may be formed in two sides of an inner wall 3416 of the accommodating chamber 3414. The limiting assembly 3480 may further include latch assemblies 3500, and the latch assemblies 3500 may be fixed on two sides of the housing 3450 and may be elastically latched with the latching holes 3418 on the two sides of the accommodating chamber 3414. “The inner wall 3416 of the accommodating chamber 3414” here may be side walls located on two sides in a traveling direction of the vehicle body 3410. Specifically, one end of the housing 3450 may be provided with the second limiting portion 3482 above, and the two latch assemblies 3500 may be fixed on two sides of the other end of the housing 3450 respectively.

Therefore, in some embodiments, when the charging assembly 3440 is to be mounted on the vehicle body 3410, one end of the charging assembly 3440 may be positioned first by plug-in fit of the first limiting portion 3481 and the second limiting portion 3482. Afterwards, locking of the other end of the charging assembly 3440 and the vehicle body 3410 may be achieved by latching fit of the latch assemblies 3500 and the latching holes 3418, rapid mounting of the other end of the charging assembly and the vehicle body may be completed, and the mounting efficiency of the charging assembly 3440 may be improved. When the charging assembly 3440 is to be detached from the vehicle body 3410, unlocking can be done by pressing the latch assemblies 3500 on the two sides at the same time, which facilitates subsequent detaching, checking and repairing of the charging assembly 3440. Compared to a traditional locking method using a plurality of screws, in such embodiments, the charging assembly 3440 may adopt the latch assemblies 3500 for fixing, which can decrease mounting and detaching steps, improve the detaching and mounting efficiency of the charging assembly 3440, help avoid screw loosening occurring due to vibration of the vehicle body 3410 in the walking process of the work robot 30, and enhance the connection stability of the charging assembly 3440.

Here, a specific structure of the latch assemblies 3500 as well as a connection method for the latch assemblies 3500 and the housing 3450 may be illustrated.

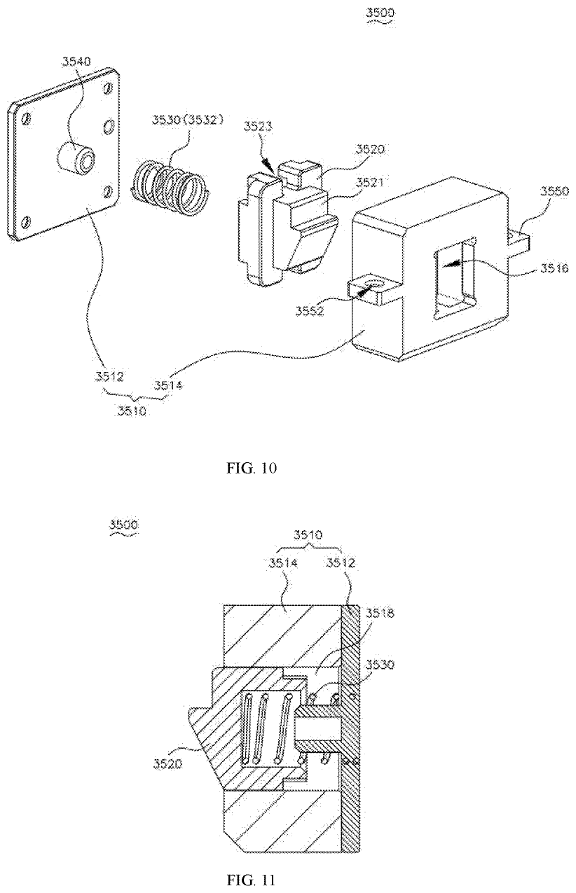

Referring to FIG. 10 and FIG. 11, each latch assembly 3500 may include a shell 3510, a latch bolt 3520 and an elastic member 3530. The shells 3510 may be mounted on an outer side of the housing 3450, the latch bolts 3520 may be slidably mounted in the shells 3510 and may be capable of protruding and extending relative to the shells 3510 so as to be latched with the latching holes 3418, and the elastic members 3530 may be disposed between the shells 3510 and the latch bolts 3520. Since the elastic members 3530 in the embodiments may abut against the locations between the shells 3510 and the latch bolts 3520, the latch bolts 3520 may move in a deformation direction of the elastic members 3530 to achieve latching with the latching holes 3418.

Specifically, each shell 3510 may include a base 3512 and a hood 3514, wherein the hood 3514 may be connected to the housing 3450 and may be fixedly connected to the base 3512 to form a cavity for accommodating the latch bolts 3520 and the elastic members 3530. For example, the hoods 3514 and the bases 3512 may be buckled with each other to form the above cavities. The hoods 3514 may be provided with through holes 3516 which may penetrate through two opposite sides of the hoods 3514. The latch bolts 3520 may be provided with latching portions 3521, and the latching portions 3521 may penetrate through the through holes 3516 and may movably protrude and extend outside of the shells 3510 and may be latched with the latching holes 3418.

In the process of pressing the charging assembly 3440 into the vehicle body 3410, the latch bolts 3520 of the latch assemblies 3500 may be in a compressed state, and when the latch bolts 3520 reach the locations of the latching holes 3418, the latch bolts 3520 may pop up under the action of the elastic members 3530 and may be latched with the latching holes 3418, so that the charging assembly 3440 and the vehicle body 3410 may be locked together. During detaching, the latch bolts 3520 of the latch assemblies 3500 on the two sides of the vehicle body 3410 may be pressed at the same time to stress and compress the elastic members 3530, and the latch bolts 3520 may be removed from the latching holes 3418, so that the latch assemblies 3500 and the latching holes 3418 may be separated; and then the charging assembly 3440 may be lifted to complete detaching.

In some embodiments, the elastic members 3530 may be springs 3532, and each latch assembly 3500 further may include a guide pillar 3540 disposed in the corresponding shell 3510, wherein the guide pillar 3540 may be disposed on one side of the corresponding base 3512 facing the corresponding hood 3514 and fixedly connected to the base 3512. For example, each guide pillar 3540 and the corresponding base 3512 may be of an integrally formed structure. Part of the structure of the springs 3532 may be sleeved over peripheries of the guide pillars 3540. The guide pillars 3540 may limit the springs 3532, and may also prevent bending of the springs 3532, so that the service life of the springs 3532 may be extended.

In some embodiments, one of each shell 3510 and the corresponding latch bolt 3520 may be provided with a guide platform 3518, the other one may be provided with a guide groove 3523, and the guide platforms 3518 and the guide grooves 3523 may be in a movable nested fit, so that the sliding stability and sliding precision of the latch bolts 3520 in the shells 3510 can be improved. In the embodiments shown in FIG. 10, the guide grooves 3523 may be formed in the latch bolts 3520, the guide platforms 3518 may be disposed on the hoods 3514, and there may be many guide grooves 3523 and guide platforms 3518 to better limit a moving direction of the latch bolts 3520.

Referring to FIG. 9 again, the charging assembly 3440 may further include a fixing platform 3453 disposed on the housing 3450, each latch assembly 3500 further may include a lug 3550 disposed on the corresponding shell 3510, and the shells 3510 may be connected to the fixing platform 3453 through the lugs 3550. Specifically, each latch assembly 3500 may include two lugs 3550 which may be located on two opposite sides of a body of the corresponding hood 3514 respectively. One side of the housing 3450 may be connected with two fixing platforms 3453 in one-to-one correspondence to the two lugs 3550, wherein at least part of structures of the two fixing platforms 3453 and the housing 3450 may be of an integrally formed structure, and the two lugs 3550 and the bodies of the hoods 3514 may be of integrally formed structures.

As an implementation, the lugs 3550 may be latched or bonded to the corresponding fixing platforms 3453. As another implementation, each latch assembly 3500 may further include a fastening member 3560, and the lugs 3550 may be connected to the fixing platforms 3453 through the fastening members 3560. For example, the lugs 3550 may be provided with penetrating holes 3552, and the fastening members 3560 may penetrate through the penetrating holes 3552 and then may be connected to the fixing platforms 3453. Specifically, the fastening members 3560 may be pins or screws.

The embodiments provide the autonomous device 340, the work robot 30, and the charging system 10. The autonomous device 340 may be configured to be charged via the charging pile 20, and the autonomous device 340 may include the vehicle body 3410, the traveling assembly 3420, the storage battery 3430, and the charging assembly 3440. The traveling assembly 3420 may be disposed at the bottom of the vehicle body 3410 and configured to drive the vehicle body 3410 to perform a moving operation. The storage battery 3430 may be mounted on the vehicle body 3410. The charging assembly 3440 may be configured to be coupled to the charging pile 20 so as to receive the electric energy from the charging pile 20 to charge the storage battery 3430, and the charging assembly 3440 may be disposed at the bottom of the vehicle body 3410.

Since the charging assembly 3440 may be disposed at the bottom of the vehicle body 3410, when the work robot 30 is parked on the base plate 210 of the charging pile 20 for charging, the power assembly 230 may be located under the charging assembly 3440. Thus, the present disclosure may adopt the bottom-to-top charging structure of the power assembly 230 and the charging assembly 3440, and the entire vehicle body 3410 may shield the charging assembly 3440 disposed at the bottom of the vehicle body 3410. When the work robot 30 works outdoors on a snowy day, the vehicle body 3410 may prevent snow from falling to the surface of the charging assembly 3440, so that difficult charging caused by snow accumulation or agglomeration on the surface of the charging assembly 3440 may be mitigated, which facilitates the work robot 30 in completing a charging task.

In the present disclosure, certain terms are used in the specification and claims to refer to specific assemblies. Those skilled in the art should understand that hardware manufacturers may refer to the same assembly by different names. The specification and claims do not distinguish assemblies based on differences in names, but based on differences in their functions. The term “comprise”, as used throughout the specification and claims, is an open-ended term and shall be construed as “including but not limited to”. The term “approximately” means that those skilled in the art can solve the technical problem within a certain range of errors and generally achieve the technical effect.

In the descriptions of the present disclosure, it is understood that directional or positional relationships indicated by the terms “upper”, “lower”, “front”, “back”, “left”, “right”, “inner” and the like are based on the directional or positional relationships shown in the accompanying drawings, and are only for the convenience of describing the present disclosure and simplifying the description, rather than indicating or implying that the apparatus or element is required to have a specific orientation and be constructed and operated in a specific orientation, thus cannot be understood as a limitation of the present disclosure.

In the present disclosure, unless otherwise expressly specified or defined, the terms “mounted”, “connected”, “coupled”, “fixed” and the like shall be construed broadly. For example, it may be a fixed connection, a detachable connection, or an integrated connection; it may be a mechanical connection or an electrical connection; and it may be a direct connection, or an indirect connection via an intermediate medium, and it may also be the internal communication between two elements, or merely surface contact. To those of ordinarily skill in the art, the specific meanings of the above terms in the present disclosure may be understood according to specific circumstances.

In the descriptions of the specification, descriptions with reference to the terms “one embodiment,” “some embodiments,” “examples,” “specific examples,” or “some examples” means that specific features, structures, materials, or characteristics described in conjunction with the embodiments or examples are included in at least one embodiment or example of the present disclosure. In the specification, the schematic expressions of the above terms do not necessarily refer to the same embodiments or examples. Moreover, the specific features, structures, materials, or characteristics described may be combined in any one or more embodiments or examples in an appropriate manner. In addition, those skilled in the art may combine the different embodiments or examples described in the specification, as well as the features of the different embodiments or examples, without conflicting with each other.

In addition, the terms “first” and “second” are only for descriptive purposes and should not be understood as indicating or implying relative importance or implicitly specifying the quantity of technical features indicated. Therefore, features that are defined by “first” and “second” can explicitly or implicitly include at least one of these features. In the descriptions of the present disclosure, the meaning of “a plurality of” is at least two, such as two and three, unless otherwise explicitly and specifically defined.

Finally, it should be noted that: the above embodiments are only used to illustrate the technical solutions of the present disclosure, not to limit it; although the present disclosure has been described in detail with reference to the above embodiments, those ordinarily skilled in the art should understand that: they can still modify the technical solutions recorded in the above embodiments or make equivalent replacement for part of the technical features; and these modifications or replacements do not separate the essence of the corresponding technical solutions from the spirit and scope of the technical solutions of the embodiments of the present disclosure.

1-26. (canceled)

27. An autonomous device, comprising:
a vehicle body;
a traveling assembly configured to drive the vehicle body to move the autonomous device;
a battery disposed in the vehicle body; and
a charging assembly configured to be coupled to a charging pile to receive electric energy from the charging pile to charge the battery, wherein the charging assembly is disposed at a bottom of the vehicle body.

28. The autonomous device of claim 27, wherein:
the charging pile includes a transmitting coil;
the charging assembly includes a housing and a receiving coil;
the housing is disposed at the bottom of the vehicle body;
the receiving coil is configured to be coupled to the transmitting coil; and
the receiving coil is disposed in the housing and electrically connected to the battery.

29. The autonomous device of claim 28, wherein:
the housing is fixed to the bottom of the vehicle body;
the housing includes a charging surface corresponding to the transmitting coil; and
the charging surface protrudes from a bottom surface of the vehicle body.

30. The autonomous device of claim 28, comprising an actuator, wherein:
an accommodating chamber is disposed at the bottom of the vehicle body;
the actuator and the housing are disposed in the accommodating chamber;
the actuator is operatively coupled to the housing and is configured to move the housing within the accommodating chamber to switch between an extended state and a retracted state;
the housing includes a charging surface corresponding to the transmitting coil;
in the extended state, the charging surface protrudes from a bottom surface of the vehicle body; and
in the retracted state, the charging surface is at least partially retracted into the accommodating chamber.

31. The autonomous device of claim 28, wherein the housing is detachably disposed in an accommodating chamber at the bottom of the vehicle body.

32. The autonomous device of claim 31, comprising a limiting assembly detachably connecting the housing to the vehicle body.

33. The autonomous device of claim 32, wherein the limiting assembly includes:
a first limiting portion at one end of the accommodating chamber and connected to the vehicle body; and
a second limiting portion on the housing, wherein the second limiting portion engages the first limiting portion to fix a mounting location of the housing.

34. The autonomous device of claim 33, wherein one of the first and second limiting portions is a boss and the other is a groove, and wherein the boss is at least partially nested within the groove.

35. The autonomous device of claim 32, wherein:
an inner wall of the accommodating chamber defines latching holes;
the limiting assembly includes latch assemblies fixed to the housing; and
the latch assemblies are elastically latched with the latching holes.

36. The autonomous device of claim 35, wherein:
at least one latch assembly of the latch assemblies includes a shell mounted to an outer side of the housing, a latch bolt, and an elastic member;
the latch bolt is slidably mounted in the shell and is configured to protrude from the shell to latch with one of the latching holes; and
the elastic member is disposed between the shell and the latch bolt.

37. The autonomous device of claim 36, wherein:
the shell includes a base and a hood connected to the housing and fixed to the base;
the hood defines a through hole; and
the latch bolt includes a latching portion configured to penetrate the through hole and protrude from the shell to latch with the one of the latching holes.

38. The autonomous device of claim 37, wherein:
the elastic member includes a spring;
the at least one latch assembly includes a guide pillar disposed in the shell; and
the spring is at least partially sleeved over the guide pillar.

39. The autonomous device of claim 38, wherein:
one of the shell and the latch bolt includes a guide platform, and the other includes a guide groove; and
the guide platform is movably nested within the guide groove.

40. The autonomous device of claim 39, wherein:
the charging assembly includes a fixing platform on the housing;
the at least one latch assembly includes a lug on the shell; and
the shell is connected to the fixing platform via the lug.

41. The autonomous device of claim 27, wherein the charging assembly includes a coil positioning sensor configured to detect a location of the charging assembly relative to the charging pile.

42. The autonomous device of claim 41, wherein the coil positioning sensor includes at least one inductor configured to detect a magnetic field intensity of a marking coil of the charging pile.

43. The autonomous device of claim 41, comprising a controller in communication with the coil positioning sensor, wherein the controller is configured to:
receive a signal indicating an electromagnetic wave detected by the coil positioning sensor; and
determine the location of the charging assembly based on the received signal.

44. The autonomous device of claim 27, comprising a baffle assembly including two baffles, wherein:
the traveling assembly spaces the bottom of the vehicle body from a ground surface and includes two crawler tracks located on opposite sides of the vehicle body;
the charging assembly is at least partially exposed at the bottom of the vehicle body in a space between the two crawler tracks; and
the two baffles are respectively disposed on side faces of the two crawler tracks to at least partially shield the space between the two crawler tracks.

45. A work robot, comprising:
an autonomous device including:
a vehicle body;
a traveling assembly configured to drive the vehicle body to move the autonomous device;
a battery disposed in the vehicle body; and
a charging assembly configured to be coupled to a charging pile to receive electric energy from the charging pile to charge the battery, wherein the charging assembly is disposed at a bottom of the vehicle body; and
a work implement connected to the vehicle body, wherein the work implement includes at least one of a snow removing implement, a snow rolling implement, a snow throwing implement, a weeding implement, a mowing implement, a leaf blowing implement, a salt spreading implement, a roller brush assembly, or a snow pushing implement.

46. A charging system comprising:
a work robot including:
an autonomous device including:
a vehicle body;
a traveling assembly configured to drive the vehicle body to move the autonomous device;
a battery disposed in the vehicle body; and
a charging assembly disposed at a bottom of the vehicle body; and
a work implement connected to the vehicle body, wherein the work implement includes at least one of a snow removing implement, a snow rolling implement, a snow throwing implement, a weeding implement, a mowing implement, a leaf blowing implement, a salt spreading implement, a roller brush assembly, or a snow pushing implement; and
a charging pile including a base plate and a power assembly, wherein:
the power assembly is disposed on the base plate and is configured to couple with the charging assembly to charge the battery;
the base plate is configured to receive the work robot; and
when the work robot is parked on the base plate, the power assembly is located under the charging assembly.
